(19) United States
(12) Patent Application Publication
(10) Pub. No.: US 2003/0152110 A1
(43) Pub. Date: Aug. 14, 2003

(54) Synchronization of remote network nodes

(76) Inventor: Johan Rune, Lidingo (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/067,838

(22) Filed: Feb. 8, 2002

(51) Int. Cl. H04J 3/06

(52) U.S. Cl. 370/509; 370/516

(57) ABSTRACT

In a network which includes a plurality of nodes with unsynchronized clocks, a message which is used by the destination node to determine the offset of the destination node's clock relative to the source node's clock is sent along a route between the source node and the destination node. At each node along the route it is determined whether the particular node is a slave node with respect to the node which transmitted the message to the particular node or whether the particular node is a slave node with respect to the node to which the message is to be forwarded. If the particular node is a slave node with respect to the node which forwarded the message, the node adds an offset with respect to the master node to the accumulated offset in the message. If the node is a slave node with respect to the node to which the message is to be forwarded, the node subtracts an offset with respect to the master node from the accumulated offset in the message. The result of the additions and subtractions of the offset are included as an accumulated offset in the message and forwarded to the next node in the route. When the message is received by the destination node, the destination node can use the accumulated offsets to determine the relative offset with respect to the source node. The source node and destination node can then exchange time information which is meaningful to both nodes.

### BACKGROUND

The present invention relates to ad-hoc networks. More particularly, the present invention relates to clock synchronization in ad-hoc networks.

Conventional networking protocols are based on the characteristics and/or features of fixed networks. In fixed networks, the network configuration typically does not change. Although nodes can be added and removed in fixed networks, the route traveled by data packets between two nodes typically does not change. The disadvantage is that fixed networks cannot be easily reconfigured to account for increases in data traffic, also called system loading. Accordingly, when system loading increases for one node, the surrounding nodes are likely to experience increased delays in the transmission and reception of data.

In contrast to fixed networks, ad-hoc networks are dynamic. An ad-hoc network is formed when a number of nodes decide to join together to form a network. Since nodes in ad-hoc networks operate as both hosts and routers, ad-hoc networks do not require the infrastructure required by fixed networks. Accordingly, ad-hoc networking protocols are based upon the assumption that nodes may not always be located at the same physical location.

Bluetooth is an exemplary ad-hoc networking technology. Bluetooth is an open specification for wireless communication of both voice and data. It is based on a short-range, universal radio link, and it provides a mechanism to form small ad-hoc groupings of connected devices, without a fixed network infrastructure, including such devices as printers, PDAs, desktop computers, FAX machines, keyboards, joysticks, telephones or virtually any digital device. Bluetooth operates in the unlicenced 2.4 GHz Industrial-Scientific-Medical (ISM) band.

FIG. 1 illustrates a Bluetooth piconet. A piconet is a collection of digital devices, such as any of those mentioned above, connected using Bluetooth technology in an ad-hoc fashion. A piconet is initially formed with two connected devices, herein referred to as nodes. A piconet can include up to eight nodes. In each piconet, for example piconet 100, there exists one master node and one or more slave nodes. In FIG. 1 Bluetooth unit 101 is a master node and Bluetooth unit 102 is a slave node.

According to Bluetooth technology, the only node in a piconet which a slave node can communicate directly with is a master node. FIG. 2 illustrates a piconet with a master node 201 and a plurality of slave nodes 202-208 arranged in a star network topology. If slave node 202 wishes to communicate with slave node 206, slave node 202 would have to transmit the information it wished to communicate to master node 201. Master node 201 then transmits the information to slave node 206. In addition to being classified as a master node and slave node, a node may be classified as an idle node. An idle node is a node which is not currently participating in a piconet.

A scatternet is formed by multiple independent and unsynchronized piconets. FIG. 3 illustrates an exemplary scatternet 300. In FIG. 3, piconet 1 includes a master node 303 and the slave nodes 301, 302 and 304; piconet 2 includes the master node 305 and the slave nodes 304, 306, 307 and 308; and piconet 3 includes the master node 309 and the slave nodes 308, 310 and 311. To implement a scatternet it is necessary to use nodes which are members of more than one piconet. Such nodes are herein referred to as forwarding nodes. If, for example, node 301 wishes to communicate with node 310, then nodes 304 and 308 might act as forwarding nodes by forwarding data between the two piconets and in particular between nodes 301 and 310. For example, node 301 transfers the information to the master node of piconet 1 node 303. Master node 303 transmits the information to forwarding node 304. Forwarding node 304 then forwards the information to master node 305, which in turn, transmits the information to forwarding node 308. Forwarding node 308 forwards the information to master node 309 which transmits the information to the destination node 310. Although not illustrated in FIG. 3, it should be recognized that a node may act as the master in one piconet and a slave in another piconet.

Bluetooth nodes communicate using a frequency hopping scheme which consists of 79 separate frequencies. The particular frequency hop sequence for a piconet is based upon the address of the master node, and the phase of the frequency hop sequence is based on the clock of the master node. Therefore, proximate piconets may operate based on different frequency hop sequences. Having only a single transceiver, a Bluetooth node can only be active in one piconet at a time. Thus, participation in multiple piconets is performed on a time division basis.

When temporarily “leaving” a piconet to be active in another piconet, a node may take measures to avoid being polled by the master node of the piconet from which it will be temporarily absent. Such measures may be to enter the HOLD mode, to use the SNIFF mode or to use a mechanism dedicated for this purpose. The HOLD mode is a single sleep mode period, the duration of which is agreed between the master node and the slave node before the slave node enters the HOLD mode. If, for instance, the HOLD mode is used by a node to facilitate participation in more than one piconet, the node enters a HOLD mode in one piconet while participating in another piconet. For example, after master node 303 forwards a packet to forwarding node 304, forwarding node 304 enters a HOLD mode with respect to piconet 1 and participates in piconet 2 so that forwarding node 304 can forward the packet to master node 305. The SNIFF mode can simply be described as a repetitive cycle of active mode behavior, i.e., the slave node listens for transmissions from the master node and responds when it is addressed, and a sleep mode, i.e., when the master node will not poll the slave node and the slave node will not listen for transmissions from the master node. The HOLD mode is not repetitive as the SNIFF mode.

Since many Bluetooth devices are battery powered and low power consumption is desirable, the SNIFF and HOLD modes are mainly intended to be used to save power. The SNIFF and HOLD modes are two of the three power saving modes specified in Bluetooth; the third one is the PARK mode. All three of them reduce the fraction of the time that a Bluetooth slave node has to listen for transmissions from its master node. For more information regarding HOLD modes in Bluetooth networks, the interested reader should refer to U.S. Pat. No. 6,026,297 “Contemporaneous Connectivity To Multiple Piconets” to Jaap Haartsen, the entire disclosure of which is herein expressly incorporated by reference. In addition, both the SNIFF mode and the HOLD mode are described in the Bluetooth Core 1.0b and the Bluetooth Core 1.1 specifications from the Bluetooth Special Interest Group (SIG), the entire contents of both of these documents is herein expressly incorporated by reference. It would also be possible for a node to switch to another piconet without changing modes or informing the master node in the first piconet in any manner. In this case, the master node of the piconet from which the node is temporarily absent may waste capacity on polling the temporarily absent node. Nevertheless, as long as the node returns to the first piconet before the master node breaks the connection due to lack of responses from the absent node, a node may participate in another piconet without informing the master node of the piconet from which the node is absent.

Each Bluetooth node has a globally unique 48 bit IEEE 802 address. This address, called the Bluetooth Device Address (BD_ADDR), is assigned when the Bluetooth node is manufactured and it is never changed. In addition, the master node of a piconet assigns a local active member address (AM_ADDR) to each active member of the piconet. The AM_ADDR, which is only three bits long, is dynamically assigned and deassigned and is unique only within a single piconet. The master node uses the AM_ADDR when polling a slave node in a piconet. However, when the slave node, triggered by a packet from the master node addressed with the slave node's AM_ADDR, transmits a packet to the master node, it includes its own AM_ADDR (not the master node's) in the packet header.

Even though all data is transmitted in packets, the packets can carry both synchronous data, on Synchronous Connection Oriented (SCO) links which is mainly intended for voice traffic, and asynchronous data, on asynchronous connectionless links (ACL) links. Depending on the type of packet that is used, an acknowledgment and retransmission scheme is used to ensure reliable data transfer, as well as forward error correction (FEC) in the form of channel coding. Due to the time sensitive nature of the data, acknowledgment and retransmission is not employed for SCO packets transferring synchronous data.

Since ad-hoc networks are dynamic, ad-hoc networking technology typically has a neighbor discovery feature. The neighbor discovery feature allows one node to find any other node with which the first node can communicate, and consequently form an ad-hoc network with. A neighbor discovery procedure in Bluetooth is known as the INQUIRY procedure. Once a Bluetooth node knows of a neighboring node, a Bluetooth node can connect to the neighboring node using the PAGE procedure.

The neighbor discovery procedure essentially consists of a first node sending an INQUIRY message and a second node responding with an INQUIRY RESPONSE message. The INQUIRY RESPONSE message is really an FHS (Frequency Hop Synchronization) packet. A FHS packet is illustrated in FIG. 4. The FHS packet includes fields for parity bits, lower address part (LAP), Scan Repetition (SR), Scan Period (SP), upper address part (UAP), non-significant address part (NAP), class of device, AM_ADDR, internal value of the node's clock (CLK), and Page Scan Mode. The LAP, UAP and NAP together comprise the BD_ADDR. The SR, SP and Page Scan Mode fields are control parameters used during the PAGE procedure. The AM_ADDR field can be used to assign an AM_ADDR to a Bluetooth node which is becoming a slave in a piconet, i.e., the AM_ADDR field is used only when the FHS packet is used in the PAGE procedure, and the undefined field is reserved for future use.

An FHS packet is also used for other purposes in a Bluetooth system, e.g., for synchronization of the frequency hop channel sequence. By listening for INQUIRY RESPONSE messages, the Bluetooth node that initiated the INQUIRY procedure can collect the BD_ADDR and internal clock values, both of which are included in the FHS packet, of the neighboring Bluetooth nodes. Since the first node has the BD_ADDR and the clock of the second node and the second node does not have this information about the first node, the first node is the only one which can initiate the PAGE procedure. Accordingly, if the first node determines that it should establish a piconet with the second node, the first node transmits a PAGE message and the second node responds with a PAGE RESPONSE message.

When a Bluetooth node desires to establish a connection with a neighboring node the Bluetooth node sends a PAGE message. A PAGE message consists of the Device Access Code (DAC) which is derived from the BD_ADDR of the paged Bluetooth node. A Bluetooth node receiving a PAGE message including its own DAC responds with an identical packet, i.e., a packet including only the DAC of the paged Bluetooth node. The paging Bluetooth node then replies with an FHS packet, including the BD_ADDR of the paging Bluetooth node, the current value of the internal clock of the paging Bluetooth node, the AM_ADDR assigned to the paged Bluetooth node and other parameters. The paged Bluetooth node then responds with its DAC and thereby the connection between the two Bluetooth nodes is established.

If the paging Bluetooth node is already the master of a piconet, the paged Bluetooth node has now joined this piconet as a new slave node. Otherwise, the two Bluetooth nodes have just formed a new piconet with the paging Bluetooth node as the master node. Since the INQUIRY message does not include any information about its sender, in particular not its BD_ADDR, the Bluetooth node that initiated the INQUIRY procedure is the only one that can initiate a subsequent PAGE procedure. Thus, the Bluetooth node initiating an INQUIRY procedure will also be the master of any piconet that is formed as a result of a subsequent PAGE procedure. However, if considered necessary, the roles of master and slave can be switched using a master-slave-switch mechanism. This, however, can be a complex and extensive procedure, potentially resulting in a redefinition of the entire piconet, involving all other slave nodes in the piconet.

FIGS. 5A and 5B respectively illustrate the current and a proposed protocol stack for Bluetooth nodes. In FIG. 5A, the protocol stack, from the lowest layer to the highest layer, includes the baseband layer, the data link layer including the link management protocol (LMP) and the logical link control and adaptation protocol (L2CAP), the network layer and generally the higher layer protocol or the application layer.

In order to support Internet Protocol (IP) in a Bluetooth scatternet, it has been proposed to regard an entire Bluetooth scatternet as an IP subnet. However, to do this requires an adaptation layer. Accordingly, FIG. 5B includes the proposed network adaptation layer between the data link layer and the network layer to allow Bluetooth nodes to communicate using IP.

Referring again to both FIGS. 5A and 5B, a host controller interface (HCI) is between the data link layer and the physical layer of the Bluetooth protocol stack. It will be recognized that the HCI is not in fact a part of the protocol stack, but is illustrated in FIGS. 5A and 5B to help explain the relation of the HCI to the protocol stack. FIG. 6 illustrates the relationship between the HCI and other components of a Bluetooth node. As illustrated in FIG. 6, the HCI exists between the host portion of a Bluetooth node and the hardware/firmware portion of the Bluetooth node. Essentially, the HCI allows the Bluetooth host access to low level function of the Bluetooth node. Low level functions include, but are not limited to, configuration of functions, setting of parameters, reading of parameters and real-time data, enabling, disabling, initiating and terminating functions. For more information regarding the HCI the interested reader should refer to Bluetooth Core 1.0b the specification of the Bluetooth system published by the Bluetooth Special Interest Group, the entire disclosure of which is herein expressly incorporated by reference.

As discussed above, the particular hop sequence for a piconet is 5555 based upon the address of the master node, and the phase of the hopping sequence is based on the clock of the master node. However, every Bluetooth node operates according to its own free running clock, i.e., the clocks between Bluetooth nodes, including the clocks of a master node and a corresponding slave node, are not synchronized. So that a master node and a slave node operate in synchrony, the slave node maintains an offset value which is equal to the offset between the master node's clock and the slave node's clock. If a slave node is a member of more than one piconet, the slave node stores an offset value between its clock and the clock of a master node in each piconet in which the slave node participates. The accuracy of the offset should not exceed ±10 μs, and it can be updated at every transmission from a master node. To participate in any one particular piconet, the slave node can determine the phase of the frequency hopping sequence of the particular piconet by determining a value which is equal to the slave node's own clock value minus the offset from the master node's clock value.

The clock of a Bluetooth node operates on a cycle between 0 and (2²⁸−1). Accordingly, the clock of a Bluetooth node can at a given time have a value between 0 and (2²⁸−1), totally independent of the values of clocks of neighboring connected nodes. The clock of a Bluetooth node is also stepped independently of the clocks of neighboring connected nodes, i.e., the instants when the clock of one node is stepped is not necessarily aligned with the stepping of clocks of any other node. Further, the frequency of the clock of a particular Bluetooth node will drift independently of the clocks of other Bluetooth nodes. However, the maximum allowed drift of any particular node's clock is ±20 parts per million (ppm). Accordingly, when the clock of any particular node is compared to the clock of another node, the mutual drift between the nodes' clocks may be between 0 and ±40 ppm.

It will be recognized that the timing characteristics for a message being forwarded between two nodes through a scatternet is heavily dependent on the inter-piconet scheduling algorithm selected. Although there are many different types of inter-piconet scheduling algorithms which can be selected, the common properties between these algorithms are summarized to highlight the problems encountered when trying to synchronize two nodes which are more than one hop away from each other and when attempting to convey accurate timing information between nodes in a scatternet.

Since a forwarding node can only actively participate in one piconet at a time, the forwarding node has to switch its presence between the piconets if the node is to forward traffic between piconets. Accordingly, streaming of information between piconets is not possible. Since information cannot be streamed between piconets, a delay is introduced with each hop that the information traverses. This delay is dependent upon the frequency of piconet switches and to a lesser extent on the size of the buffers in the forwarding node. The lower the frequency of switches between piconets, the longer a delay is introduced into the forwarding of the information.

Additionally, there is a delay involved with each piconet switch in terms of lost time slots. Since the clocks of the master nodes of different piconets are not synchronized, a forwarding node will lose at least one frame every time the node switches between piconets. The relative overhead resulting from the piconet switching increases with the switching frequency. Accordingly, it can be seen that there is a trade-off between delay and overhead.

The amount of time a particular forwarding node spends in any particular piconet will vary depending upon traffic load, the number of piconet memberships for the forwarding node, and the number of nodes in each piconet. Further, different forwarding nodes may employ different inter-piconet scheduling algorithms, with a standardized interface. Regardless, the delay in every forwarding node, in addition to the accumulated delay of other nodes in the route between a source and destination node, will at a minimum be a couple of frames, but may be on the order of tens or even hundreds of frames.

Since the clocks of two Bluetooth nodes connected to the same scatternet are unsynchronized and slowly drift compared to each other, and since the time required to transfer a message across multiple piconets between a source node and a destination node is almost completely unpredictable, it is very difficult to synchronize a source and destination node which are more than a few hops from each other. Further, it is difficult to convey accurate timing between a source and destination node which are more than a few hops away from each. Such accurate timing information would be useful, for example, to enable accurate scheduling of a PAGE procedure in order to establish a direct connection between two remote nodes, i.e., nodes with at least one intermediate node in the route, desiring to communicate with each other. Accordingly, it would be desirable to provide methods and apparatus for synchronizing two nodes in a scatternet and to convey accurate timing information between two nodes in a scatternet.

### SUMMARY

These and other problems, drawbacks and limitations of conventional techniques are overcome according to the present invention.

The present invention generally involves a node by node accumulation of clock offsets between each pair of adjacent nodes in a route between a source node and a destination node. In general, the offset between the clock of a slave node and the clock of its master node is always known by the slave node in order to synchronize the slave node's transmissions and receptions with the master node. However, the master node does not maintain this offset information. Accordingly, the present invention relies upon offset calculations performed by slave nodes in the route between the source node and the destination node, including the end nodes if they are slave nodes. Only if a master node is also a slave node in another piconet, and this slave node is a part of the route, does the master node perform the offset calculations.

The offsets are accumulated by a message that is passed along the route from the source node to the destination node. Each node which is a slave node with respect to another node in the route, receiving the message calculates its own relevant offset, if any, with respect to the node or nodes in the route which is a master of the slave node. An offset between the slave node and a master node is added, by the slave node, to the accumulated offset in the message if the slave node received the message from the master node, and an offset between the slave node and a master node is subtracted from the accumulated offset in the message if the slave node is to forward the message to a master node. After any offsets have been added or subtracted from the accumulated offset in the message, the message is forwarded to the next node in the route. When the message reaches the destination node, the message will include the complete accumulated offset between the source and destination nodes. The calculation of the accumulated offset of all nodes in the route between a source node and a destination node provides the offset between the clocks of the source and destination nodes. Once this offset is determined the absolute value of the other node's clock can be calculated by subtracting the accumulated offset from the node's own clock value. The absolute clock value can then be used as a time reference.

In accordance with one aspect of the present invention, a method for synchronizing a source node and a destination node in an ad-hoc network is provided. A message is transferred from the source node to the destination node over a route between the source and destination nodes. The message is received by each node in the route. An offset in the message is accumulated as the message is forwarded through the route, wherein whether the accumulation is performed by a particular node in the route is based on a relationship between the particular node and either a node from which the message is received, or a node to which the message is forwarded by the particular node. Each node in the route forwards the message to a next node in the route between the source and destination nodes. The destination node determines an offset with respect to the source node. The source node and the destination node synchronize using the offset determined by the destination node.

In accordance with another aspect of the present invention, a network is provided. The network includes a source node which generates a message and transmits the message in a route between the source node and a destination node. The network also includes at least one intermediate node in the route between the source and destination nodes, wherein an offset is accumulated in the message as the message is transmitted in the route between the source node and the destination node, wherein whether accumulation is performed by the at least one intermediate node based on a relationship between the at least one intermediate node and either a node from which the at least one intermediate node received the message, or a node to which the at least one intermediate node is to forward the message. The destination node determines an offset relative to the source node using the offset accumulated in the message and synchronizes with the source node using the offset determined by the destination node.

### BRIEF DESCRIPTION OF THE DRAWINGS

The objects and advantages of the invention will be understood by reading the following detailed description in conjunction with the drawings in which:

FIG. 1 illustrates an exemplary piconet;

FIG. 2 illustrates an exemplary star-topology network;

FIG. 3 illustrates an exemplary scatternet formed by a plurality of piconets;

FIG. 4 illustrates a conventional FHS Bluetooth packet;

FIGS. 5A and 5B respectively illustrate the protocol layers of the current Bluetooth protocol and of an Internet Protocol compatible Bluetooth protocol;

FIG. 6 illustrates the relationship between the HCI and other components of a Bluetooth node;

FIG. 7 illustrates an exemplary scatternet for synchronizing two nodes of the scatternet in accordance with exemplary embodiments of the present invention;

FIG. 8 illustrates an exemplary method for a source node in accordance with one embodiment of the present invention;

FIG. 9 illustrates an exemplary method for a node between a source and destination node in accordance with one embodiment of the present invention;

FIG. 10 illustrates an exemplary method for a destination node in accordance with one embodiment of the present invention;

FIG. 11 illustrates the ambiguity which can arise when transferring a point in time between a source and destination node;

FIG. 12 illustrates an exemplary method for a source node in accordance with another embodiment of the present invention;

FIG. 13 illustrates an exemplary method for a node between a source and destination node in accordance with another embodiment of the present invention; and

FIG. 14 illustrates an exemplary method for a destination node in accordance with another embodiment of the present invention.

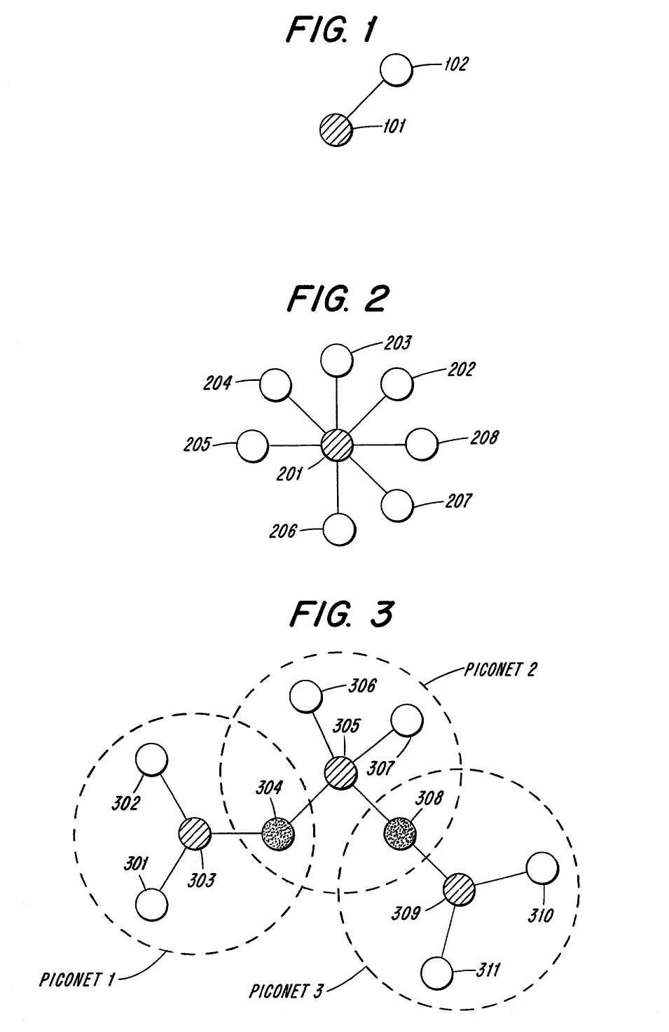

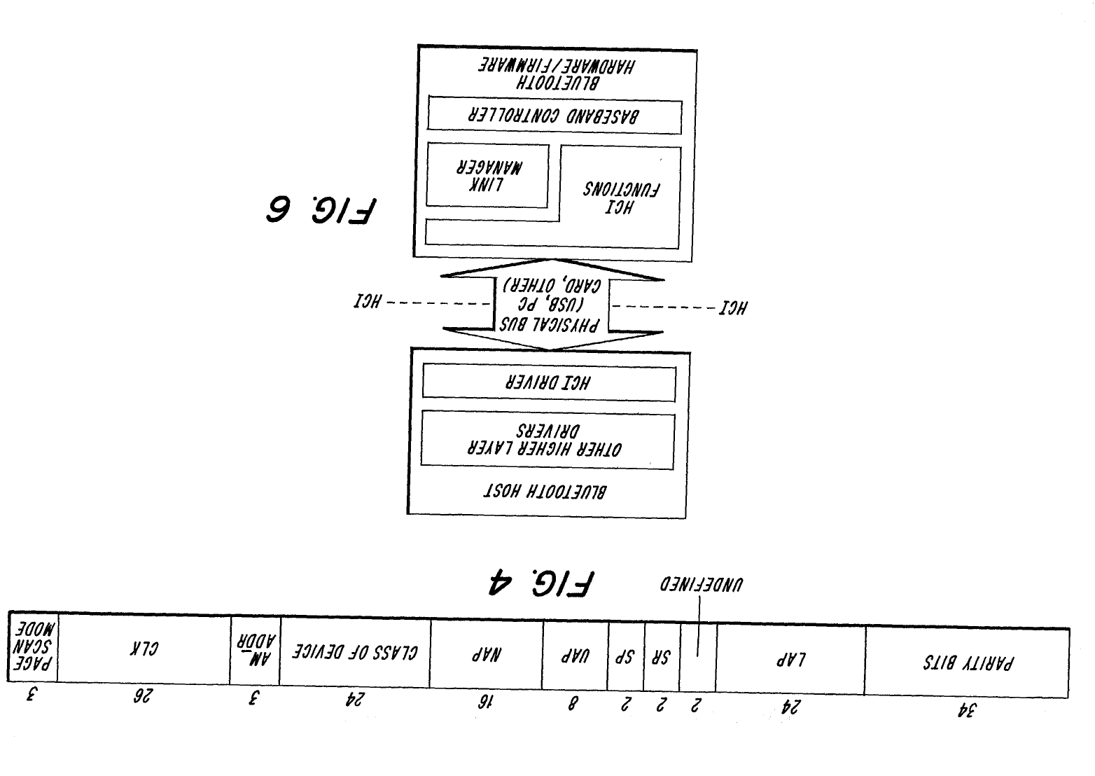

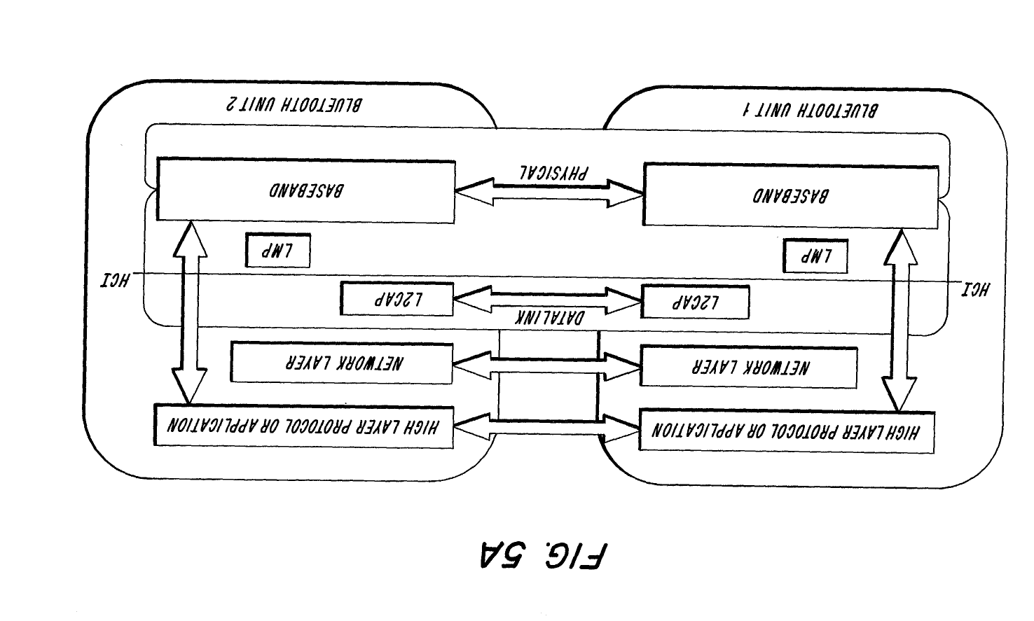

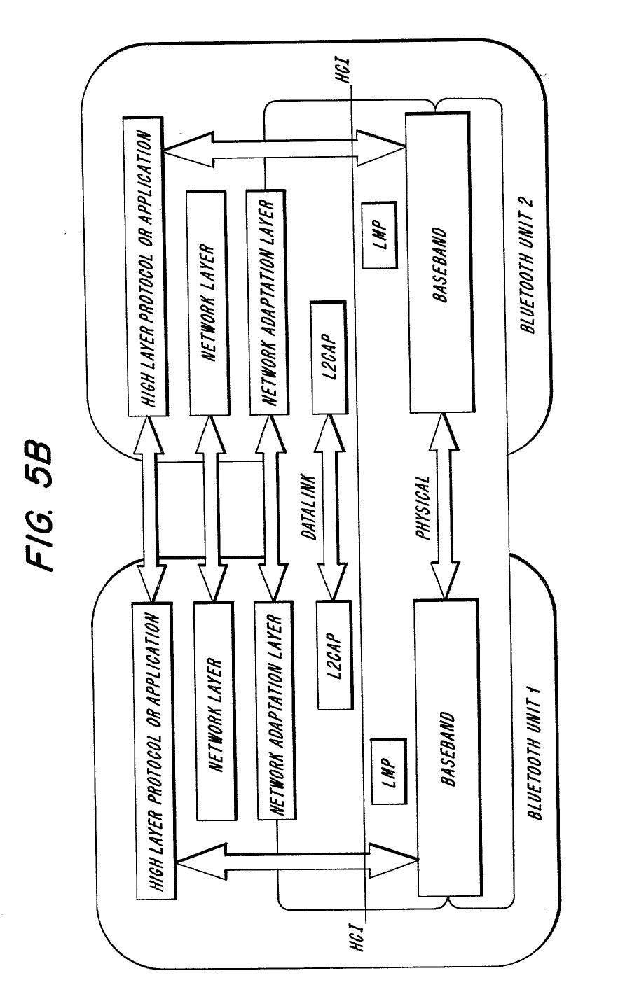

### DETAILED DESCRIPTION

The present invention is directed to ad-hoc networks. More particularly, the present invention is directed to synchronizing and conveying accurate timing information between two nodes of a scatternet.

In the following description, for purposes of explanation and not limitation, specific details are set forth, such as particular sequences of inter and intra network signaling, types of messages, etc. in order to provide a thorough understanding of the present invention. However, it will be apparent to one skilled in the art that the present invention may be practiced in other embodiments that depart from these specific details. In other instances, detailed descriptions of well-known methods, devices, and network elements are omitted so as not to obscure the description of the present invention.

The present invention can synchronize and convey timing information between two nodes either by employing features which exist in the HCI interface or by employing features which are not currently standardized for the HCI interface. A description of the present invention employing existing features of the HCI interface will be presented first, and a description of the present invention employing extended HCI features will follow.

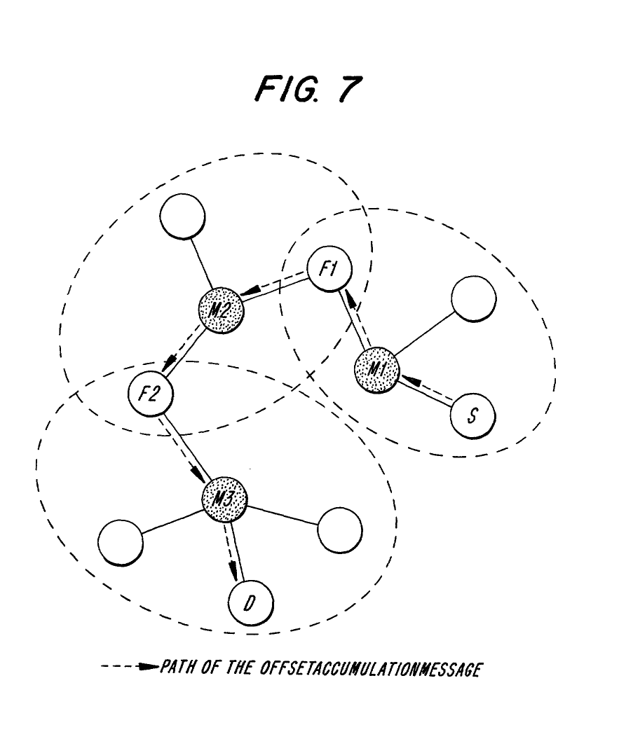

FIG. 7 illustrates an exemplary scatternet which can convey timing information between two nodes in accordance with the present invention. The scatternet illustrated in FIG. 7 consists of eleven nodes variously distributed throughout three piconets. In FIG. 7, a route between a source node S and a destination node D includes, in sequential order, master node M1, forwarding node F1, master node M2, forwarding node F2 and master node M3. Although FIG. 7 illustrates the source, destination, and forwarding nodes as slave nodes, it will be recognized that this need not be the case. Further, although FIG. 7 illustrates a scatternet with three piconets and eleven nodes, the present invention is equally applicable to any number of piconets consisting of any number of nodes.

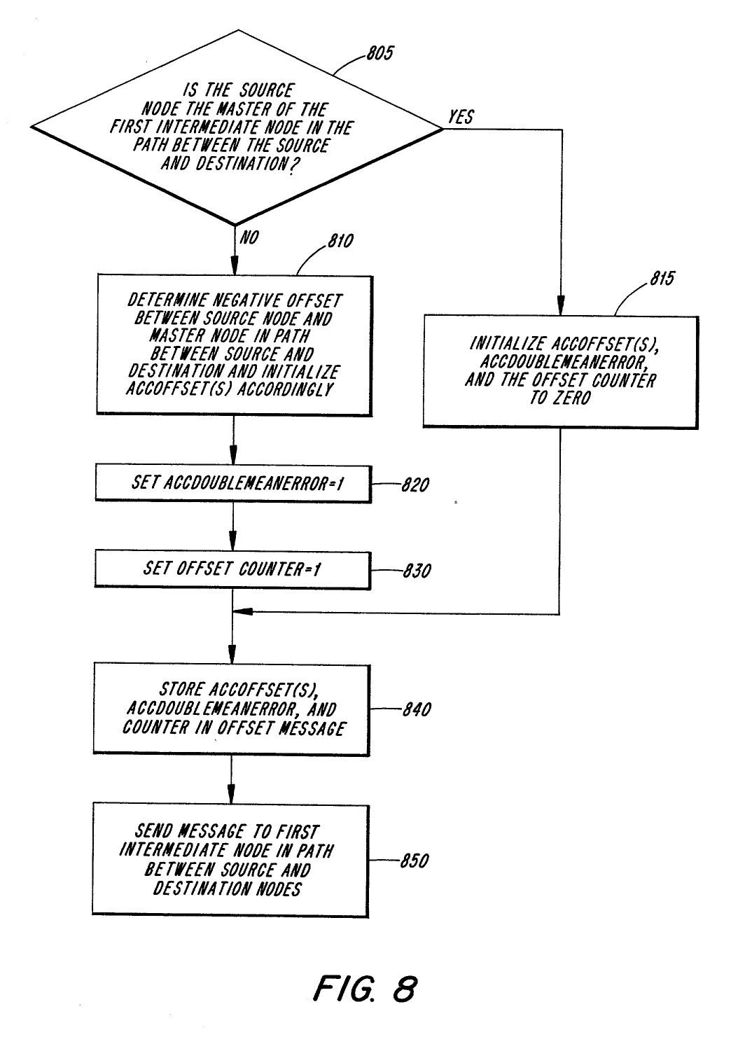

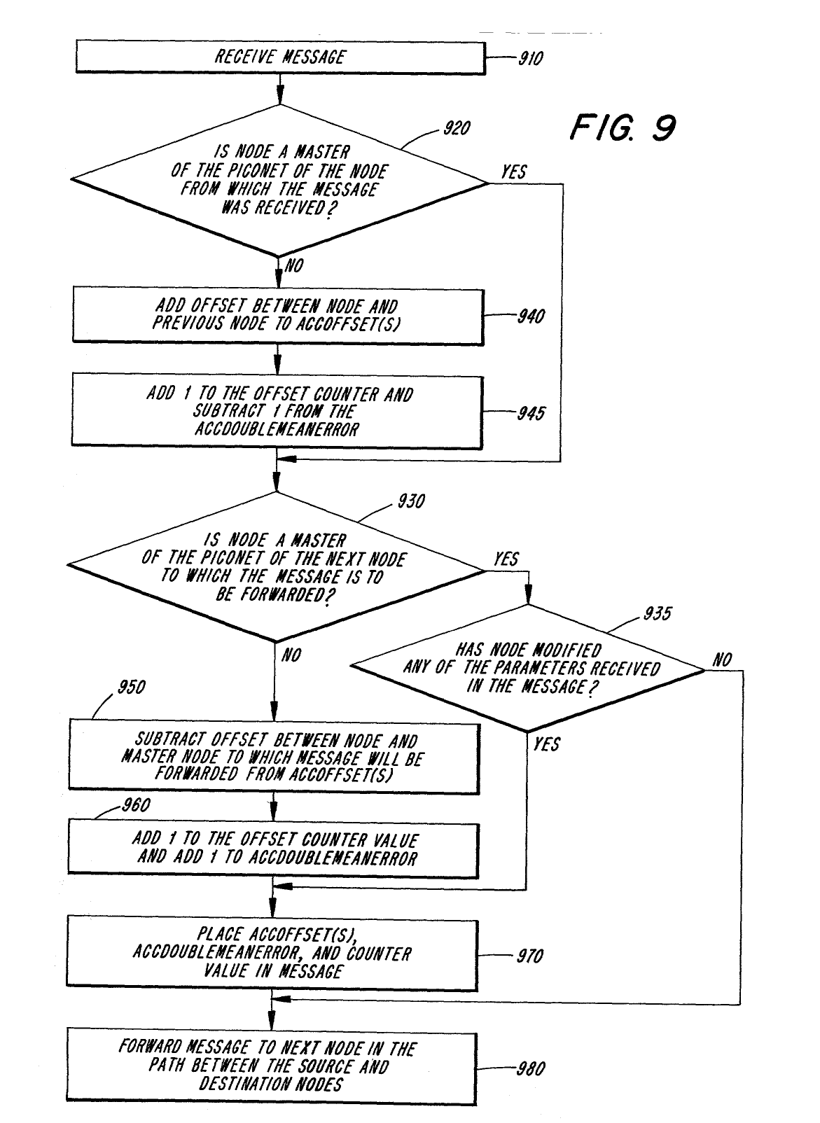

FIGS. 8-10 respectively illustrate exemplary methods for a source node, an intermediate node and a destination node. Although not explicitly indicated in the discussion below, all offset calculations described in connection with FIGS. 8-10 are performed modulo 2¹⁵. In the calculations the offset value returned by the Read Clock Offset Complete event, when calculated between a slave node X and a master node M, is denoted Offset(X,M). The parameter containing the accumulated offset relative to a node Y is denoted AccOffset(Y). The total accumulated offset between two nodes Z and Y is denoted TotAccOffset(Z,Y).

FIG. 8 illustrates an exemplary method for a source node in accordance with the present invention. Referring now to FIGS. 7 and 8, initially, source node S, which is a slave node in the example illustrated in FIG. 7, determines whether it is the master of the first intermediate node in the route between the source and destination nodes (step 805). If the source node is the master node of the first intermediate node (“Yes” path out of decision step 805), then the node initializes the AccOffset(S), AccDoubleMeanError and the Offset counter to zero (step 815). If the source node is not the master node of the first intermediate node (“No” path out of decision step 805), as is the case in the example illustrated in FIG. 7, then the source node calculates the offset between its clock and the clock of master node M1, and sets the accumulated offset equal to the negative of the offset, i.e., AccOffset(S)=−Offset(S,M1) (step 810). In accordance with the first exemplary embodiment of the present invention, the clock offset that is retrievable via the current HCI interface is used as the offset between a node's own clock and a connected node's clock. This offset is requested using the HCI_Read_Clock-Offset command. If the node is a slave node, and consequently the connected node is a master node, the offset of the master node's clock is continuously tracked at the baseband layer, and therefore, is always known by the slave node. The requested offset can then be immediately returned in a Read Clock Offset Complete event.

It should be noted that the offset retrieved using the HCI_Read_Clock_Offset command is not the complete offset value. Instead, the offset is bits 2-16, with bit numbers starting with the least significant bit 0, of the difference between the clock of the slave node and the clock of the master node, i.e., CLKₛₗₐᵥₑ−CLKₘₐₛₜₑᵣ. This clock sub-parameter has a granularity of one frame, i.e., 1.25 milliseconds, and a cycle of 2¹⁵=32768 frames, i.e., 40.96 s. This cycle will be herein referred to as CLK₁₆₋₂ subcycle, as compared to the complete clock cycle of 2²⁶ frames. Accordingly, the offset value returned in the Read Clock Offset Complete event is always the offset of the slave node's clock relative to the master node's clock.

Since an error between 0 and 1 frames is added to the accumulated error of the accumulated offset for every offset between a particular pair of adjacent nodes that is added to the accumulated offset, the granularity of one frame is a significant limitation to the accuracy of the accumulated offset. The error due to this granularity will always be negative, i.e., the returned offset will always be less than or equal to the real offset, disregarding the up to ±10 μs inaccuracy in the slave node's continuous tracking of the clock offset relative to the master node. Accordingly, the present invention compensates for this accumulated error to ensure the accuracy of the complete accumulated offset.

One method for estimating this error is to add 0.5 frames, i.e., the mean value of the error range of 0 and 1 frame, to each accumulated slave-master clock offset. Another method for estimating this error is to use a separate parameter to accumulate the opposite sign of each accumulated offset. This separate parameter is decreased by one when an offset value is added, and increased by one when an offset value is subtracted. In accordance with the present invention, offset values are added when the slave receives the offset accumulation message from a master node (i.e., the slave node is located downstream relative to its master in the route between the source node and destination node), and subtracted when the slave node is to forward the offset accumulation message to a master node (i.e., the slave node is located upstream relative to its master node). The parameter is included in the same message in which the accumulated offset is stored. When the accumulation is complete, the parameter will contain the net number of added or subtracted offsets with the opposite sign, i.e., the double mean error of the accumulated offset. The node processing the accumulated offset uses this parameter to adjust the value of the accumulated offset to achieve a better accuracy of the offset between the source node's clock and the destination node's clock.

To enable calculation of the probability distribution of the accumulated error offset value (which can be used for statistical estimations of the accuracy of the offset), an offset counter can be used to indicate the number of offset calculations performed to arrive at the accumulated error offset value. The offset counter is included in the message along with the accumulated offset. The offset counter is increased by one for each offset that is added to the accumulated offset. Since the offset counter essentially represents the number of hops between the source node and the destination node, if a hop count between the nodes is already known, from for example, a route request which preceded the accumulated offset request procedure, the offset counter need not be implemented. It should be recognized that the offset counter parameter is not needed to calculate the accumulated offset and is merely used in estimating the accuracy of the accumulated offset. Accordingly, referring again to FIG. 8, the source node S, which is a slave node in the example illustrated in FIG. 7, sets the accumulated double mean error equal to one and the offset counter equal to one, i.e., AccDoubleMeanError=1 (step 820) and OffsetCounter=1 (step 830). After the source node sets the OffsetCounter=1 (step 830) or after the source node has initialized the various parameters (step 815), the source node then stores the AccOffset(S), AccDoubleMeanError and OffsetCounter parameters in an OffsetAccumulationMessage (step 840) and sends it to the first intermediate node in the route between the source and destination nodes (step 850). Although FIG. 8 has been described in connection with the example in FIG. 7 where the source node is a slave node with respect to the next node in the route between the source and destination nodes, a source node which is a master node relative to the next node in the route between the source node and the destination node would follow the “Yes” path out of decision step 805.

FIG. 9 illustrates an exemplary method for a node in between a source node and a destination node in accordance with the present invention. Initially, a node receives the message (step 910). The node then determines whether it is a master of the piconet of the node from which the message was received (step 920). If, a node is not a master of the piconet of the node from which the message was received (“No” path out of decision step 920) then the node, e.g., forwarding node F1, adds the offset between its clock and master node M1's clock to the accumulated offset in the OffsetAccumulation message (step 940), and adds 1 to the OffsetCounter and subtracts 1 from the AccDoubleMeanError (step 945).

If a node determines that it is a master node (“Yes” path out of decision step 920) or after the node has added 1 to the OffsetCounter and has subtracted 1 from the AccDoubleMeanError (step 945), then the node determines whether it is a master of the piconet of the next node to which the OffsetAccumulation message is being forwarded (step 930). If the node is a master of the piconet (“Yes” path out of decision step 930), then the node determines whether it has modified any of the parameters received in the message (step 935). If the node has not modified any of the parameters received in the message (“No” path out of decision step 935), then the node forwards the message to the next node in the route between the source and destination nodes (step 980).

If the node is not a master of the piconet of the next node to which the OffsetAccumulation message is being forwarded (“No” path out of decision step 930) then the node subtracts the offset between its clock and master node M2's clock from the accumulated offset (step 950). The forwarding node F1 also increments the offset counter by one, and adds 1 to the AccDoubleMeanError (step 960). After 1 has been added to the offset counter value and 1 has been added to the AccDoubleMeanError (step 960) or if the node has modified any of the parameters in the message (“Yes” path out of decision step 935) then the forwarding node F1 stores the AccOffset(S), OffsetCounter and AccDoubleMeanError values in the OffsetAccumulationMessage and forwards the message to master node M2 (steps 970 and 980). It should be noted that when a node is a slave with respect to the node from which the message was received and with respect to a node to which the message is to be forwarded, the AccDoubleMeanError parameter is unchanged because one offset is added for master node M1 and one offset is subtracted for master node M2, thereby eliminating each other's mean error, i.e., AccDoubleMeanError=AccDoubleMeanError−1+1.

Master node M2 receives the OffsetAccumulationMessage (step 910); determines that it is the master of the piconet of the node from which the message was received (“Yes” path out of decision step 920); determines that it is the master of the piconet of the next node to which the message is to be forwarded (“Yes” path out of decision step 930); determines that it has not modified any of the parameters received in the message (“No” path out of decision step 935); and forwards the message to the next node in the route between the source and destination nodes. In the example illustrated in FIG. 7, forwarding node F2 performs similar functions to those described above in connection with forwarding node F1 and master node M2 performs similar functions to those described above in connection with master node M1.

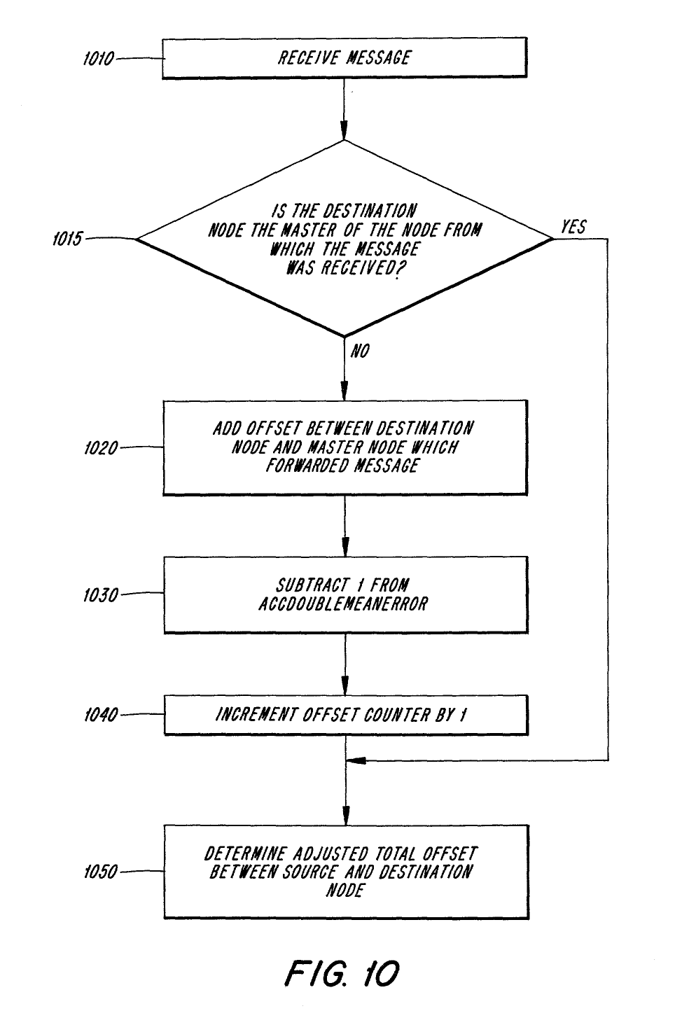

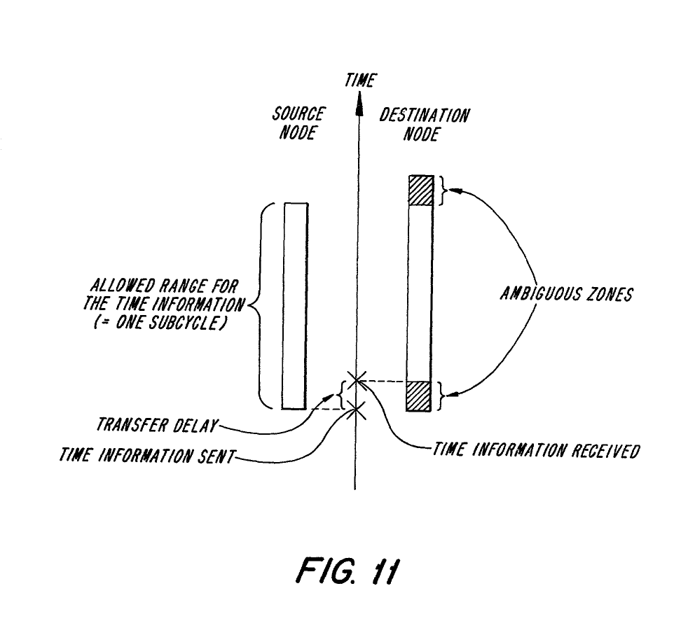

FIG. 10 illustrates an exemplary method for a destination node in accordance with the first embodiment of the present invention. Initially, the destination node, e.g., destination node D of FIG. 7, receives the message (step 1010). The destination node D, which is a slave node in the example illustrated in FIG. 7, determines whether it is a master of the node from which the message was received (step 1015). If the node is the master node of the node from which the message was received (“Yes” path out of decision step 1015), then the node determines the adjusted total offset between the source and destination nodes (step 1050).

If the destination node is not the master of the node from which the message was received (“No” path out of decision step 1015), then the node determines the total accumulated offset between its clock and the source node's clock by adding its offset relative to the master node from which the message was received to the accumulated offset, i.e., TotAccOffset(D,S)=AccOffset(S)+Offset(D,M3) (step 1020). The destination node D also subtracts one from the AccDoubleMeanError parameter (step 1030) and adds one to the offset counter value (step 1040), i.e., TotAccDoubleMeanError=AccDoubleMeanError−1 and TotOffsetCounter=OffsetCounter+1. Using the accumulated offset, the destination node determines the adjusted total accumulated offset, to account for the accumulated error. This is performed by first subtracting half of the total accumulated double mean error (which is equal to the total accumulated mean error) from the total accumulated offset, and then multiplying the result by 4. The multiplication by 4 converts the unit of the adjusted total accumulated offset from frames to the basic unit of the clock, which is ¼ frame (312.5 microseconds). Thus, the resulting calculations are performed in accordance with the following equation: AdjustedTotAccOffset(D,S)=4*TotAccOffset(D,S)−2*TotAccDoubleMeanError (step 1050).

The destination node may also perform error calculations to determine the error resulting from the coarse granularity in the offset values returned by the Read Clock Offset Complete event. One type of error that can be calculated is the maximum offset accumulation error E_{offsetCalcMax}. To determine the maximum offset accumulation error E_{offsetCalcMax} the number of added offsets and the number of subtracted offsets are calculated using equations (1) and (2) below:

Number of added offsets=(TotOffsetCounter−TotAccDoubleMeanError)/2 (1)

Number of subtracted offsets=(TotOffsetCounter+TotAccDoubleMeanError)/2 (2)

Next, the maximum positive offset error and the maximum negative offset error are calculated using equations (3) and (4) below:

MaxPosError=(TotOffsetCounter+TotAccDoubleMeanError)/2−TotAccDoubleMeanError/2 (3)

MaxNegError=−(TotOffsetCounter−TotAccDoubleMeanError)/2−TotAccDoubleMeanError/2 (4)

Reducing equations (3) and (4) above results in:

MaxPosError=TotOffsetCounter/2 frames; and

MaxNegError=−TotOffsetCounter/2 frames.

Thus, after subtracting the estimated accumulated mean error the maximum offset accumulation error E_{offsetCalcMax}=±TotOffsetCounter/2 frames. Adjusting the maximum error for half-slot units results in an adjusted maximum offset error of:

E_{adjustedOffsetCalcMax}=4*E_{OffsectCalcMax}=±2*TotOffsetCounter (5)

Although the maximum offset error may occur, it is very unlikely that it will occur. Accordingly, a more valuable measure of the error is to determine the percentile probability intervals, i.e., the intervals within which the error will be with a certain probability. An error interval with a 90% probability error E_{offsetCalc90%} is more likely to occur. A 90%-probability-error-interval for an offset accumulation calculation involving the TotOffsetCounter can be denoted E_{offsetcalc90%}(TotOffsetCounter). For an accumulated calculation with the TotOffsetCounter=1, the calculation of the 90% -probability-error-interval is E_{offsetCalc90%}(1)=±0.45 frames=0.9*E_{offsetCalcMax.} For large TotOffsetCounter values, e.g., greater than 15, the error probability distribution can be reasonably well approximated with a normal distribution of:

f(E_{OffsetCalc})=1/(σ*sqrt(2π)*TotOffsetCounter)*e^{E}^{_{OffisetCalc}}^{\hat{ }2/(2*TotOffsetCounter*σ\hat{ }2)}

wherein a is the standard deviation for a single offset calculation, which means that σ=1/(sqrt(12))≈0.29 frames, since the error, after compensating for the mean error of 0.5 frames, is uniformly distributed within the ±0.5 frames. Another approximation, although not realistic in practice, is when the TotOffsetCounter value is equal to 20. This results in E_{offsetCaic90%}(20)≈±2.12 frames=0.212*E_{OffSetCalcMax.} Although not a realistic example in practice, it can be noted how much smaller the relation of E_{offsetCalc90%}(20)/E_{OffsetCalcMax} is than E_{offsetCalc90%}(1)/E_{OffsetCalcMax.} Although it can be seen from the above that the maximum error increases linearly with the number of accumulated offsets, it will also be noted that the larger the number of accumulated offsets the less probable it is that the real error is anywhere close to the maximum possible error.

Since the clock drift error of the source node relative to the destination node is insignificant compared to the accumulated error caused by the 1-frame granularity in the value returned by the Read Clock Ofset Complete event, the clock drift error can be neglected in the initial calculation of the clock offset between the source and destination nodes. Further, the drift error cannot be calculated since the time used to transfer the OffsetAccumulationMessage from the source node to the destination node is unknown. However, the more time that passes from the calculation of the total accumulated offset, the more relevant the drift error becomes. The maximum mutual drift between two nodes is 40 ppm. This results in the maximum drift error E_{driftMax}=4*10⁻⁵*T, where T is the time since the OffsetAccumulationMessage was received, ignoring the unknown transfer time for the OffsetAccumulationMessage. Accordingly, a maximum drift error of 1 frame would occur every 25000 frames=31.25 seconds.

Now that the offset between the clocks of a source node and destination node has been obtained, the use of this offset is described below to highlight some practical limitations of the use of the offset and the solutions to these limitations in accordance with the present invention. One practical limitation of the offset is that it is accumulated using only the CLK₁₆₋₂ subclock instead of the full range clock. Accordingly, the absolute time information exchanged between nodes cannot be more than one subcycle, or 2¹⁵−1 frames, in the future.

Since the absolute time information is limited by one subcycle, an ambiguity may occur with respect to the absolute time information received by the destination node. This ambiguity problem is illustrated in FIG. 11. In FIG. 11 the vertical axis represents time. It is assumed that the offset between the source node and the destination node has already been obtained through an OffsetAccumulationMessage. As illustrated by the lower “X” on the time axis, a message which refers to a point in time is sent from the source node to the destination node. After some transfer delay, the message is received by the destination node at a time represented by the higher “X” on the time axis. Since the absolute time information is limited by the CLK₁₆₋₂ subclock, the higher bits of the clock value, i.e., CLK₂₇₋₁₇ have no meaning to the destination node. Accordingly, the time information should be expressed using the 17 lowest clock bits CLK₁₆₋₀, i.e., the value that these bits will have in the source node at the referred future point in time.

When receiving the time information, the destination node can easily calculate the value that its own CLK₁₆₋₀ subclock should, ideally, have at the referred point in time. This value can be calculated by adding the total accumulated offset (multiplied by 4 to make it expressed in half-slots, like the CLK₁₆₋₀ subdlock) to the received CLK₁₆₋₀ subclock value. However, taking the maximum errors into account, the destination node can only be sure that at the referred point in time the value of its own CLK₁₆₋₀ subclock will be within the range CLK_{16-0received}+AdjustedTotAccOffset(S,D)±(E_{AdjustedOffSetCalcMax}+E_{DriftMax}), assuming that E_{DriftMax} is expressed in half-slots.

As illustrated by the two ambiguity zones in FIG. 11, an ambiguity may arise if the referred point in time is earlier in time than the receipt, due to the transfer delay, of the message by the destination node. Accordingly, upon receipt of the message containing the referred point in time, the destination node must determine whether the referred point in time is in the future, i.e., during the later in time ambiguity zone, or in the past, i.e., during the earlier in time ambiguity zone. To overcome this ambiguity problem, an assumption can be made that the message transfer delay will never exceed half a subcycle. Since half a subcycle is 20.48 s, this should be a safe assumption. Thus, if the referred point in time can be interpreted as being either in the second subcycle-half into the past or in the first subcycle-half into the future, there is no ambiguity. The correct interpretation of the referred point in time by the destination node must be the first future subcycle-half since the other alternative would imply a message transfer delay larger than half of a subcycle. On the other hand, if the referred point in time can be interpreted as being either in the first subcycle-half into the past or in the second subcycle-half into the future ambiguity arises. However, due to the assumption about a maximum possible transfer delay, this ambiguity can be resolved as explained below.

One way to resolve the ambiguity, assuming a maximum transfer delay of half a subcycle, would be to introduce a single-bit indicator for indicating whether the referred point in time, at the time of sending, was more or less than half a subcycle into the future. This indicator could be called “SubcycleHalfIndicator” and it should be transferred together with the referred point in time. Of course, it would also be possible to include the sender's subclock value at the time of sending instead of the SubcycleHalflndicator, but that would just be a less bit-efficient way to achieve the same result. If the above-described ambiguous situation occurs at the receiver, i.e., when the destination node has to determine whether the referred point in time is in the first subcycle-half into the past or in the second subcycle-half into the future, the SubcycleHalfIndicator will guide the destination node to the correct interpretation. If the SubcycleHalfIndicator indicates ‘more than half a subcycle into the future’, the correct interpretation of the received time reference is that the referred point in time is in the future, since the opposite would imply a transfer delay exceeding half a subcycle. Consequently, if the SubcycleHalfIndicator indicates ‘not more than half a subcycle into the future’, the correct interpretation of the received time reference must be that the referred point in time has already passed.

Another way of solving the ambiguity problem, still assuming a maximum transfer delay of half a subcycle, is to mandate that a referred point in time must always be less than half a subcycle away at the time of sending. The receiver then knows that a referred point in time can never be more than half a subcycle into the future, and due to the assumption about the maximum transfer delay, it cannot be more than half of a subcycle into the past either. Hence, if a referred point in time can be interpreted as being in the first subcycle-half into the past, this must be the correct interpretation. The alternative would be that the referred point in time is more than half a subcycle-half into the future, which is not allowed. Thus the ambiguity is gone. A consequence of this solution is that the allowed range of the transferred time information is reduced from 2¹⁵ to 2¹⁴ frames.

By employing the techniques described above, the accumulated offset can be used to enable transfer of absolute time information with an allowed range of 2¹⁵ frames (40.96 s), using a SubcycleHalfIndicator; or 2¹⁴ frames (20.48 s), using the reduced range method to deal with the ambiguity problem. This range should be sufficient for many applications. It certainly is enough for the PAGE scheduling mechanism. However, to completely avoid this ambiguity problem it would be desirable to extend the allowed range of the absolute time information, making it virtually unlimited.

The basic procedure, as described above in connection with FIGS. 7-10, allows the two involved nodes to establish a mutual point of reference in terms of a mutually known point in time. This is achieved by first calculating the total accumulated offset between the two nodes and then transferring from one node to the other node a subclock value referring to a certain point in time. Using the calculated total accumulated offset, the node which receives the referred point in time will be able to convert the received subdlock value into a value of its own subclock. Thus the referred point in time becomes a mutually known point of reference.

Now any point in time can be referred to by indicating its position relative to the mutual point of reference. The relative time position is preferably indicated with a granularity of ¼ frames, i.e. 312.5 microseconds, since this is the granularity of a Bluetooth clock. Thus, when the total accumulated offset has been calculated, any point in time can be referred to by transferring a subclock value (to establish a mutual point of reference), possibly together with a SubcycleHalfIndicator, and a relative time indication indicating the time difference between the referred point in time and the mutual point of reference.

Since the purpose of the transferred subclock value is to establish a mutual point of reference, as long as it is known by both the involved nodes, it does not matter what subclock value that is chosen. Thus, one may avoid using bits in the message to refer to a specific point in time, and instead, use a predefined default subclock value. This default subclock value may e.g. be the all-zero value. Using a default subdlock value, only the relative time indication needs to be transferred between the nodes. The point of reference for all relative time indications should be the next point in time when the value of the subclock is equal to the default subclock value. The calculations in the node receiving the referred point in time, using the total accumulated offset to calculate the value of its own subclock when the value of the sending node's subclock is equal to the default subclock value, can be performed using the techniques described above.

It should be noted that when a default subclock value is used at the time of sending the time information, the next occurrence of the default subdlock value might be up to a full subcycle into the future. Therefore, the reduced range method used to avoid the ambiguity problem cannot be used in combination with a default subclock value. Instead, the SubcycleHalfIndicator method should be used. Since at the time of sending the relative time information the default mutual point of reference may be up to one subcycle into the future, the relative time information must be able to express both positive (indicating a point in time after the mutual point of reference) and negative (indicating a point in time before the mutual point of reference) time periods in relation to the mutual point of reference.

When the receiving node calculates the mutual point of reference, it should add the total accumulated subclock offset to the received CLK₁₆₋₀ subclock value or the default CLK₁₆₋₀ subclock value (e.g. all zeros), depending on which method that is used. Preferably, the receiving node should arrive at a mutual point of reference expressed as a CLK₁₆₋₀ subclock value. The calculations of the mutual point of reference in the destination node could be expressed as follows (the S=“source node” and D=“destination node” denotations are used and the use of the SubcycleHalfIndicator, when applicable, is not indicated, but is implicitly assumed).

CLK_{16-0ref}=CLK_{16-0received/default}+AdjustedTotAccOffset(D, S)=CLK_{16-0received/default}+4*TotAccOffset(D, S).

The relative time information is preferably expressed as a positive (when referring to a point in time after the mutual point of reference) or negative (when referring to a point in time before the mutual point of reference) integer number of ¼ frames.

Although the offset which is retrieved via the current HCI interface is limited to bits 2-16 of the offset, the HC/LM (Host Controller/Link Manager) entity of a slave node maintains the complete 28 bit offset between its own clock and the clock of its master. In addition, the HC/LM entity of a slave node maintains the very accurate slot offset, i.e. the offset between the slot boundaries of the master clock and the slave's own clock. Although the meaning of the term “slot offset” is recognized by those skilled in the art, to those unfamiliar with this art the term “slot offset” may be a bit misleading. What is actually tracked is the offset between the start of an even numbered time slot according to the master's clock and the start of an even numbered time slot according to the slave's own clock. Therefore, the more accurate term “frame offset” will henceforth be used. The frame offset parameter has a granularity of 1 microsecond and a range of 0-1249 microseconds. In order for the slave to be able to follow the timing of the traffic in the piconet, the frame offset must always be maintained with at least ±10 microseconds accuracy. The frame offset is a perfect complement to the clock offset expressed as a CLK₁₆₋₂ subclock value (with a granularity of 1 frame). The combination of the clock offset and the frame offset provides the complete offset between the two clocks with a granularity of 1 microsecond (although the accuracy is only ±10 microseconds). A master node does not store any clock offset data or slot/frame offset data, but, if required, it can request this information from a slave node using LMP commands.

To retrieve the full clock offset and the detailed frame offset requires the currently standardized HCI interface to be extended. Retrieval of the full clock offset can be achieved by extending the Clock_Offset parameter of the Read Clock Offset Complete event to four bytes. Retrieval of the detailed frame offset requires a new HCI command, which could be called, e.g., “HCI_Read_Frame_Offset”. Retrieval of the detailed frame offset would also require a new HCI event for the response, which could be called e.g., “Read Frame Offset Complete event”. Like the HCI_Read_Clock_Offset command, the HCI_Read_Frame_Ofset command would have Connection_Handle as its only parameter. This parameter indicates the connection, i.e., the remote node, for which the slot offset is requested. The parameters of the Read Frame Offset Complete event would be Status (including success or error indication), Connection_Handle and Frame_Offset. The Frame_Offset parameter would indicate the requested frame offset with a granularity of 1 microsecond and with a range of 0-1249 microseconds. To be consistent with the Clock_Offset parameter of the Read Clock Offset Complete event, the Frame_Offset parameter would indicate the offset with the master frame boundary as the reference. That is, if the slave's frame boundary occurs 1 microsecond after the master's, the Frame_Offset parameter would indicate ‘1 microsecond’, but if the master's frame boundary occurs 1 microsecond after the slave's, the Frame_Offset parameter would indicate ‘1249 microseconds’. Alternatively, a new HCI command could be introduced, e.g., called “HCI_Read_Clock_and_Frame_Offsets”, and a new HCI event, e.g. called “Read Clock and Frame Offsets Complete event”, with which both the clock offset (15 or 28 bits) and the frame offset could be requested and returned together.

Extending the retrievable clock offset to 28 bits is a simple extension, but in practice it does not make much difference for the conveying of time information. As described above, the currently retrievable 15-bit clock offset is enough to enable indications of any point in time using timing information relative to a mutual point of reference. Accordingly, the main advantage of employing the full clock offset is the elimination of the SubcycleHalfIndicator. This would be done by using the same principles as in the reduced range method described above, i.e., it would be mandated that a referred point in time must always be less than half a clock cycle (2²⁵−1 frames which is approximately 11 hours and 39 minutes) away at the time of sending the referred point in time. This solves the ambiguity problem in the same way as described in conjunction with the reduced range method and the allowed range for the transferred time information, almost 12 hours, should be enough for all practical purposes.

Although the benefit from extending the Clock_Offset parameter in the HCI_Read_Clock_Offset command is quite limited, a more significant improvement can be achieved by allowing the frame offset to be retrieved through the HCI, e.g. using the aforementioned HCI_Read_Frame_Offset command. The most important advantage with this would be that the maximum error associated with each offset added to the accumulated offset could be kept as low as ±10 microseconds instead of ±0.5 frames (=±625 microseconds).

The actions and calculations performed by each node in the route of the OffsetAccumulationMessage would in this case be quite similar to what is described above in connection with FIGS. 8-10. The difference would be that an accumulation of the frame offset would be performed in parallel with the clock offset accumulation. The described procedure assumes that the clock offset retrieved from the HC/LM entity is the CLK₁₆₋₂ subclock offset in the same manner as that described above in connection with the embodiment which employs the current HCI interface. If the full clock offset is used, the clock offset calculations are performed modulo 2²⁸, instead of modulo 2¹⁵. Further, instead of the frame offset, a slot offset with the range 0-624 microseconds, or even a “half slot offset” with the range 0-312 microseconds, could be used.

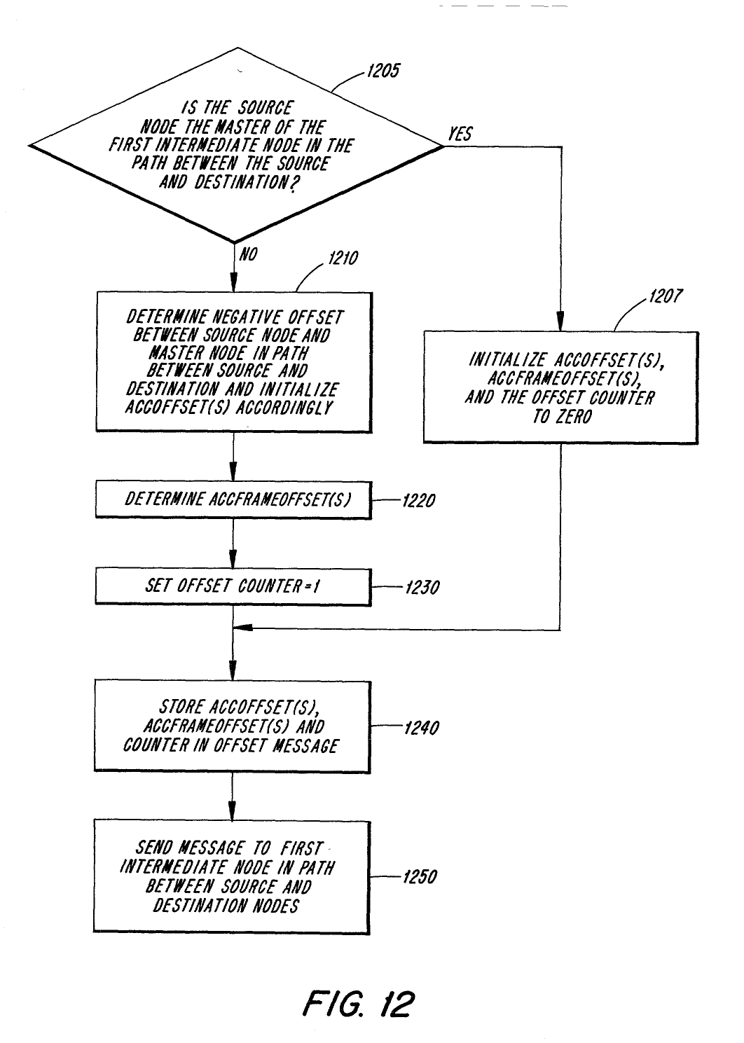

FIGS. 12-14 respectively illustrate methods performed by a source node, an intermediate node and an destination node in accordance with exemplary embodiments of the present invention. Although not indicated explicitly, all offset calculations described in connection with FIGS. 12-14 are performed modulo 2¹⁵, assuming that the CLK₁₆₋₂ subclock is used in the calculation. Referring again to FIG. 7, the actions and calculations performed by the involved nodes, as the OffsetAccumulationMessage is passed from the source node S to the destination node D, are described below. In addition to the denotations used above, the frame offset between a slave node X and a master node M, as returned by a HCI event (e.g. the suggested Read Frame Offset Complete event) is denoted FrameOffset(X, M); the parameter containing the accumulated frame offset relative a node Y is denoted AccFrameOffset(Y); and the total accumulated frame offset between two nodes Z and Y is denoted TotAccFrameOffset(Z, Y). It should be noted that the AccDoubleMeanError parameter is not needed in this case, since the error in the value returned by the Read Clock Offset Complete event is accurately compensated for by the value returned by the Read Frame Offset Complete event.

Referring now to FIG. 7 and 12, the source node determines whether it is the master of the first intermediate node in the route between the source and destination nodes (step 1205). If the node is the master of the first intermediate node (“Yes” path out of decision step 1205), then the node initializes AccOffset(S), AccFrameOffset(S) and the OffsetCounter to zero (step 1207). If the source node determines that it is not the master of the first intermediate node (“No” path out of decision step 1205), then the source node determines the negative offset between the source node and the master node in the route between the source and destination nodes (step 1210) in accordance with the following equation: AccOffset(S)=−Offset (S, M1), and initializes the AccOffset(S) accordingly. Next, the source node determines the AccFrameOffset(S) (step 1220) using the following equation: AccFrameOffset(S)=−FrameOffset(S, M1). The offset counter is set equal to one (step 1230), i.e., OffsetCounter=1. After the offset counter is set equal to one (step 1230) or after the node has initialized the various parameters (step 1207), then the source node stores the AccOffset(S), AccFrameOffset(S) and OffsetCounter parameters in an OffsetAccumulationMessage (step 1240) and sends it to the master node M1 (step 1250).

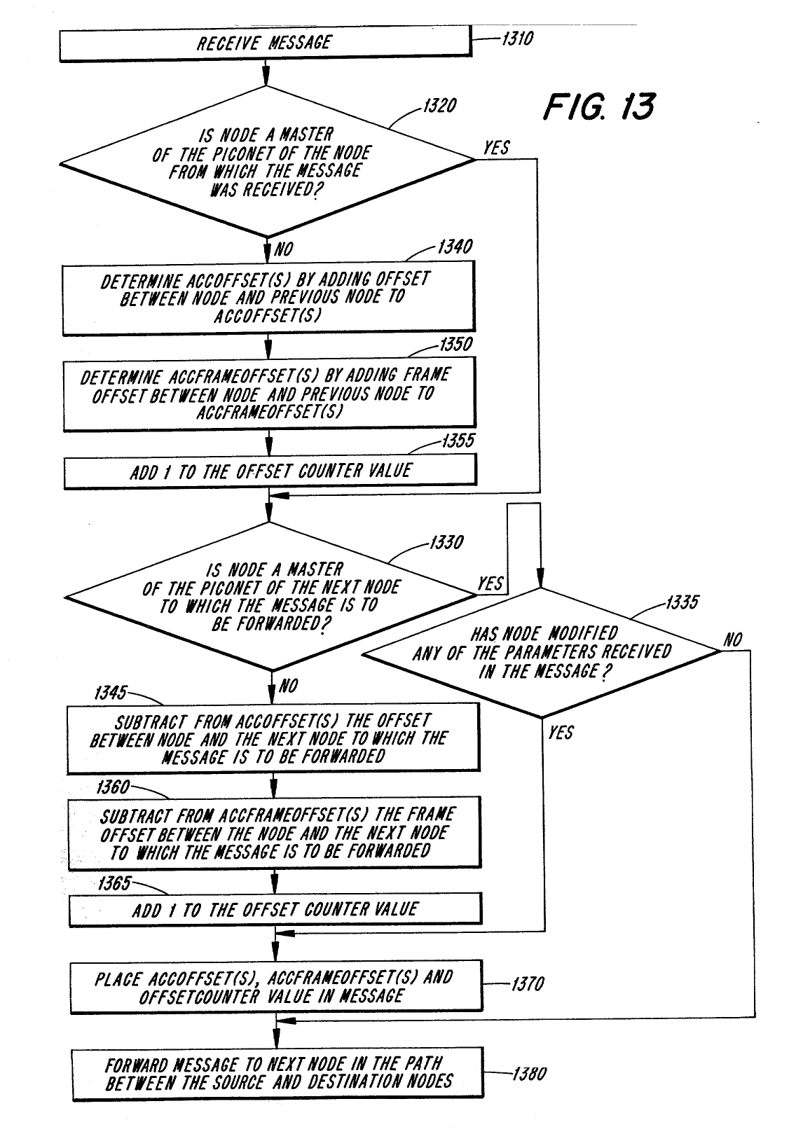

As illustrated in FIG. 7, the next node is master node M1. Referring now to FIG. 13, master node M1 receives the message from the source node (step 1310) and determines whether it is a master node of the piconet of the node from which the message was received (step 1320). Since master node M1 is a master of the source node's piconet (“Yes” path out of decision step 1320), the master node M1 determines whether it is a master of the piconet of the next node to which the message is to be forwarded (step 1330). As illustrated in FIG. 7, master node M1 is the master of forwarding node F1 (“Yes” path out of decision step 1330). Accordingly, master node M1 determines whether it has modified any of the parameters received in the message (step 1335). Since master node M1 has not modified any of the parameters in the message (“No” path out of decision step 1335), the master node M1 forwards the message to the next node in the route between the source and destination nodes, i.e., forwarding node F1, (step 1380).

Returning now to step 1330, assume now that master node M1 is not a master of forwarding node F1 (“No” path out of decision step 1330). Accordingly, the master node M1 subtracts from the AccOffset(S) the offset between the node and the next node to which the message is to be forwarded (step 1345). Next the node subtracts from the AccFrameOffset(S) the FrameOffset between the node and the next node to which the message is to be forwarded (step 1360) and adds 1 to the offset counter (step 1365). The node then places the AccOffset(S), AccFrameOffset(S) and the OffsetCounter value in the message (step 1370) and forwards the message to the next node in the route between the source and destination nodes (step 1380).

Forwarding node F1 receives the message (step 1310) and determines that it is not a master node of the piconet of the node from which the message was received (“No” path out of decision step 1320). Next, the forwarding node determines the AccOffset(S) (step 1340) by adding the offset between the node and the previous node to the AccOffset(S). The forwarding node then determines the AccFrameOffset(S) (step 1350) by adding the Frame Offset between the node and the previous node to the AccFrameOffset(S) (step 1350) and adds 1 to the offset counter value (step 1355). The forwarding node then determines whether it is a master of the piconet of the next node to which the message is being forwarded (step 1330). As illustrated in FIG. 7, forwarding node F1 is not the master of the piconet of master node M2 (“No” path out of decision step 1330). Accordingly, the master node M1 subtracts from the AccOffset(S) the offset between the node and the next node to which the message is to be forwarded (step 1345). Next the node subtracts from the AccFrameOffset(S) the FrameOffset between the node and the next node to which the message is to be forwarded (step 1360) and adds 1 to the offset counter (step 1365). The node then places the AccOffset(S), AccFrameOffset(S) and the OffsetCounter value in the message (step 1370) and forwards the message to the next node in the route between the source and destination nodes (step 1380).

Returning now to step 1330, assume now that forwarding node F1 is a master of master node M2 and that M2 consequently is a slave node (“Yes” path out of decision step 1330). Accordingly, forwarding node F1 determines whether it has modified any of the parameters received in the message (step 1335). Since forwarding node F1 has modified the parameters in the message due to its slave relation to master node M1 (“Yes” path out of decision step 1335), the forwarding node F1 places the AccOffset(S), AccFrameOffset(S) and OffsetCounter values in the message (step 1370), and forwarding node F1 forwards the message to the next node in the route between the source and destination nodes, i.e., node M2, which, as stated above, is assumed to be a slave node in this scenario (step 1380).

Master nodes M2 and M3 and forwarding node F2 perform similar actions to those discussed above in connection with FIG. 13, depending upon the particular circumstances of the node.

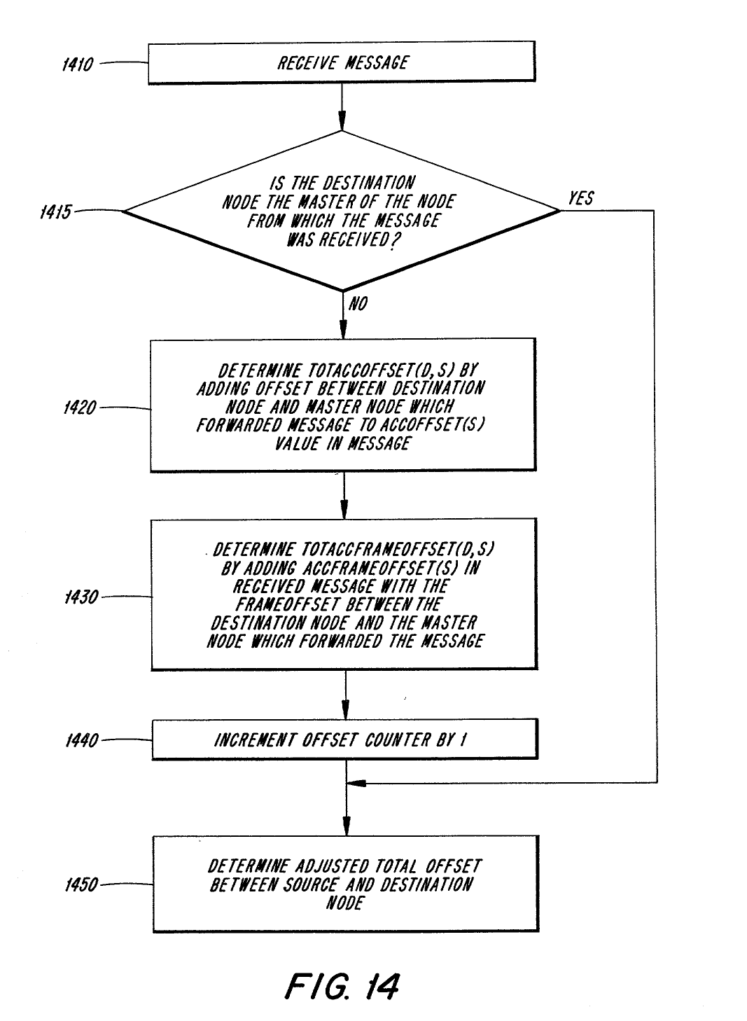

FIG. 14 illustrates an exemplary method for a destination node in accordance with exemplary embodiments of the present invention. Initially, the destination node receives the message (step 1410) and determines whether it is the master of the node from which the message was received (step 1415). If the destination node is the master of the node from which the message was received (“Yes” path out of decision step 1415), then the destination node determines the adjusted total offset between the source and destination nodes (step 1450).

If the destination node is not the master of the node from which the message was received (“No” path out of decision step 1415), then the destination node determines the TotAccOffset(D,S) (step 1420) in accordance with the following formula: TotAccOffset(D, S)=AccOffset(S)+Offset(D, M3) modulo 2¹⁵. The destination node then determines the TotAccFrameOffset(D,S) (step 1430) in accordance with the following formula: TotAccFrameOffset(D, S)=AccFrameOffset(S)+FrameOffset(D, M3). Next, the destination node determines the total for the offset counter (step 1440) in accordance with the following formula: TotOffsetCounter=OffsetCounter+1. Finally, the destination node determines the adjusted total offset (step 1450).

As in the embodiment employing the standardized HCI features, the destination node can also adjust the calculated parameters to facilitate future calculations of mutual points of reference. The TotAccOffset(D, S) parameter is adjusted to make it express the offset in half-slots instead of frames, the adjusted parameter being denoted AdjustedTotAccOffset(D, S). Then the TotAccFrameOffset(D, S) parameter is divided into an integer number of half-slots and the remaining (“sub-half-slot”) microseconds. The integer number of half-slots extracted from the TotAccFrameOffset(D, S) parameter is added to the AdjustedTotAccFrameOffset(D, S) parameter. The parameter containing the remaining (“sub-half-slot”) microseconds would be denoted AdjustedTotAccFrameOffset(D, S). The following calculations are implied (multiplications and divisions by 2 are used to compensate for the fact that the length of a half-slot (312.5 microseconds) is not an integer number of microseconds long): AdjustedTotAccOffset(D, S)=4*TotAccOffset(D, S)+2* TotAccFrameOffset(D, S)//625 (where “//” indicates integer division) AdjustedTotAccFrameOffset(D, S)=(2*TotAccFrameOffset(D, S) modulo 625)// 2 (where “//” indicates integer division).

The destination node may also perform error calculations based on the accumulation of the frame offset errors (up to ±10 microseconds in each node). Possible error parameters to calculate could be e.g. maximum error (E_{OffsetCalcMax}) or “90%-probability-error” (E_{OffsetCalc90%}). Since the frame offset is used in this case, the error calculations are of course different than those described above in connection with the embodiment employing the standardized HCI features. Especially since the error of a single frame offset will not be uniformly distributed within the interval ±10 microseconds. Instead, the error probability distribution will reveal a higher probability in the middle of the interval (i.e. around zero) than close to the end points.

Accordingly, the type of calculations described above in connection with the embodiment which employs the standardized HCI features cannot be used in the same way in this case. The maximum error can still be easily calculated as E_{OffsetCalcMax}=±TotOffsetCounter*10 microseconds, although the probability for this maximum error to occur is less. For the “90%-error-probability-interval”, E_{Offsetcalc90%}, calculations corresponding to the calculations described above in connection with the embodiment which employs the standardized HCI features, i.e., the normal distribution approximation, would result in a value which is too high. The reason is that the different error probability distribution has a standard deviation that is a smaller fraction of the total error interval in this case than in the case described above in connection with the embodiment which employs the standardized HCI features. However, corresponding calculations can be used to get an upper bound which most certainly is higher than the real value. The calculations described above in connection with the embodiment which employs the standardized HCI features can then easily be used to find this “too high value”. All that is required is to change the unit in the result from “frames” to “20 microseconds-units”. Hence, a conclusion is that for a TotOffsetCounter=20, the “90%-error-probability-interval”, E_{OffsetCalc}90%(20), will certainly be significantly smaller than ±2.12*20 microseconds=±42.4 microseconds.

The clock drift error inferred during the transfer of the OffsetAccumulationMessage cannot always be neglected in this case. In situations with long transfer delays, but still relatively few intermediate nodes, the drift error inferred during the message transfer would not always be insignificant compared to the accumulated frame offset error. However, the clock drift error inferred during the transfer of the OffsetAccumulationMessage cannot be calculated in this case either, because the message transfer time is not known. Accordingly, just as in the case of the offset calculations using existing HCI features, the drift error inferred by the time that has passed since the reception of the OffsetAccumulationMessage can be estimated. This drift error calculation is of course the same as described above in connection with the embodiment which employs the standardized HCI features. The maximum mutual clock drift between two nodes is 40 ppm. This makes the maximum drift error E_{DriftMax}=4*10⁻⁵*T, where T is the time since the OffsetAccumulationMessage was received. This means that it takes 25000 frames (=31.25 seconds) for the maximum drift error to grow to 1 frame.

The principles for how to use the calculated total accumulated offset values to enable transfer of absolute timing information between nodes in a scatternet depends on whether the CLK₁₆₋₂ subclock offset or the full clock offset (28 bits) is used during the offset accumulation. In the case when the CLK₁₆₋₂ subclock offset is used the principles are similar to those described above in connection with the embodiment which employs the standardized HCI features, with the addition of the more detailed subframe time information.

As described above in connection with the embodiment which employs the standardized HCI features a common point of reference should preferably be established, which is then used as a reference point for relative time information that can be transferred to indicate any point in time. The mutual point of reference should preferably be aligned with a subclock frame boundary of the sending node, i.e., without subframe time information, which would not serve any purpose.

The subcycle ambiguity problem associated with the establishment of the mutual point of reference is the same as described above in connection with the embodiment which employs the standardized HCI features and it is dealt with in the same ways. If the ambiguity problem is solved with a SubcycleHalfIndicator, the mutual point of reference must, at the time of sending, not be further into the future than one subcycle. If, on the other hand, the ambiguity problem is solved with the reduced range method, the mutual point of reference must, at the time of sending, not be further into the future than half a subcycle. As in the case when only existing HCI features are used, the preferred method is to use a predefined default subclock value as the common point of reference. Then only the relative time information has to be transferred. When a default common point of reference is used, it cannot be restricted to half a subcycle into the future and consequently the SubcycleHalffndicator method has to be used to handle the ambiguity problem. When the receiving node calculates the mutual point of reference, it should add the total accumulated subclock offset and the total accumulated frame offset to the received CLK₁₆₋₀ subclock value or the default CLK₁₆₋₀ subdlock value (e.g., all zeros), depending upon which method is employed. Preferably, the receiving node should arrive at a mutual point of reference expressed as a CLK₁₆₋₀ subclock value in combination with the “sub-half-slot” time period expressed in microseconds (i.e., 0-312 microseconds). The calculations of the two parts of the mutual point of reference in the destination node could be expressed as follows, wherein S denotes the source node and D denotes the destination node.

Calculation of the CLK₁₆₋₀ subclock part (CLK_{16-0ref}):

$${CLK}_{16 - Oref} = {CLK1}_{6 - Orecieved / default} + AdjustedTotAccOffset ( D , S ) = {CLK}_{16 - Oreceived / default} + 4 * TotAccOffset ( D , S ) + 2 * TotAccFrameOffset ( D , S ) // 625$$

Calculation of the “sub-half-slot” part (SHS): SHS=AdjustedTotAccFrameOffset(D ,S)=(2*TotAccFrameOffset(D ,S) modulo 625)//2

The relative time information preferably consists of two parts: a frame count, expressed as a positive (when referring to a point in time after the mutual point of reference) or negative (when referring to a point in time before the mutual point of reference) integer number of frames, and the subframe time information, expressed in microseconds ranging from 0 to 1249. Alternatively, and equally preferable, the two parts could be a (positive or negative) half-slot count and a “sub-half-slot” part ranging from 0 to 312 microseconds. For both alternatives a SubcycleHalfIndicator has to be transferred together with the relative time information to handle the ambiguity problem.

To convey absolute time information in accordance with the embodiment which employs extended HCI features and when the full clock offset is used, the relative time information should not be needed due to the long range of the full clock cycle. Instead an absolute clock value, and not a subclock value, could be transferred to indicate the actual point in time of interest, instead of a mutual point of reference to be used in subsequent calculations. The only restriction is that at the time of sending the transferred clock value must not be more than half a clock cycle (2²⁷−1 half-slots) into the future (in the sending node). This restriction is introduced to avoid the ambiguity problem as previously described. Together with the clock value “sub-half-slot” time information ranging from 0 to 312 microseconds should be transferred.

Since conveying of absolute time references in a scatternet is a multi-hop problem, it should preferably be handled by the NAL/BNEP (Network Adaptation Layer/Bluetooth Network Encapsulation Protocol) layer. Hence, the OffsetAccumulationMessage should be a NAL/BNEP message, but it could use two alternative principles for addressing and transferring. One alternative is to let the message be a NAL/BNEP message addressed to the next node or the next forwarding node in the route, including the real destination address in the message body. The message would then be received and processed by the NAL/BNEP entity of each intermediate node (or forwarding node) in the route to the destination. Each of these NAL/BNEP entities would have to extract the destination address from the message and derive the next hop node to send the OffsetAccumulationMessage to, possibly using a route request. This process could be simplified if a full hop-by-hop route to the destination is included in the initial OffsetAccumulationMessage from the source node.

The other alternative is to let the OffsetAccumulationMessage be a NAL/BNEP message addressed to the real destination. It would then include an indicator in the NAL/BNEP header indicating that the NAL/BNEP entity in each forwarding node (or in every node, if a more generic indicator is desired) should process the contents of the message before forwarding it. This indicator may be an explicit single-bit flag. But it may also be just a certain type code, or certain type codes, implicitly indicating to the NAL/BNEP entity that the message should be processed before it is forwarded.

The former approach has the disadvantages that a destination address is transported in the message body, which allegedly is a concept that is known by experience to sometimes cause problems (e.g. undetected route loops), and that a new route may have to be found by each intermediate node processing the message. An optimization possibility, particularly straightforward for the second approach, would be to let the offset accumulation parameters be piggy-backed on the message transferring the actual time information, e.g. a page scheduling message.

In the embodiments described above, it is assumed that the error of the offset returned by the Read Clock Offset event is within the interval of 0-1 frame. However, the present invention can also be implemented with the assumption that the error is instead within the interval of ±0.5 frames. This assumption eliminates the need to accumulate the double mean error when existing HCI features are used since the mean error, and in turn the accumulated mean error, will always be 0. Further, the total accumulated offset does not have to be adjusted with the total accumulated double mean error in the destination node. The calculations of the accuracy/error probability are not impacted.

When the assumption that the error is within the interval of ±0.5 frames, the embodiment described above in which the HCI features are extended does not change. Whether an assumption is made that the error interval is within ±0.5 frames or 0-1 frames will be based upon the particular standardized system in which the present invention is implemented, which can readily be determined by one of ordinary skill in the art.

Although the present invention has been described in connection with the Bluetooth protocol, it will be recognized that the present invention is equally applicable to any type of network in which nodes have unsynchronized clocks.

The present invention has been described with reference to several exemplary embodiments. However, it will be readily apparent to those skilled in the art that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method for synchronizing a source node and a destination node in an ad-hoc network comprising the steps of:
transmitting a message from the source node to the destination node over a route between the source and destination nodes;
receiving the message by each node in the route;
accumulating an offset in the message as the message is forwarded through the route, wherein whether the accumulation is performed by a particular node in the route is based on a relationship between the particular node and either a node from which the message is received, or a node to which the message is to be forwarded by the particular node;
forwarding, by each node in the route, the message to a next node in the route between the source and destination nodes;
determining, by the destination node, an offset with respect to the source node; and
synchronizing the source node and the destination node using the offset determined by the destination node.

2. The method of claim 1, wherein if the source node is a slave with respect to a next node in the route, the source node determines a negative offset between the source node and the next node, and the source node includes the negative offset in the message prior to transmitting the message to the next node in the route.

3. The method of claim 1, wherein clocks in each node in the route are not synchronized such that a clock value of one particular node is independent of a clock value of another node, and wherein a stepping of the clocks of each node is independent of each other.

4. The method of claim 1, wherein the accumulation is performed by a particular node in the route if the particular node is a slave with respect to a node which forwarded the message to the particular node, or if the particular node is a slave with respect to a node to which the particular node is to forward the message.

5. The method of claim 4, wherein an offset value is added to the offset in the message if the particular node is a slave with respect to a node which forwarded the message to the particular node, and another offset value is subtracted from the offset in the message if the particular node is a slave with respect to a node to which the message is to be forwarded by the particular node.

6. The method of claim 1, further comprising the step of:
incrementing, by the particular node, an offset counter in the message, wherein the offset counter is incremented by the particular node only if the particular node is a slave node with respect to either a node which forwarded the message to the particular node, or a node to which the particular node is to forward the message.

7. The method of claim 1, further comprising the step of:
estimating an error of the offset determined by the destination node.

8. The method of claim 1, wherein the synchronizing step comprises the steps of:
exchanging a point in time between the source node and the destination node; and
performing a task by the source node and destination node at the exchanged point in time.

9. The method of claim 8, wherein the task is page scanning, paging, inquiry scanning, inquiring, or transferring a message without prior connection establishment.

10. The method of claim 8, wherein a cycle of clocks in all of the nodes in the route is represented by a predetermined number of bits and offset values which are accumulated in the message are represented by a difference between a subcycle of a clock of a slave node and a subcycle of a clock of a master node.

11. The method of claim 10, wherein the predetermined number of bits is 28 bits which are numbered from 0 to 27 with the least significant bit being bit number 0 and the subcycle is represented using bits 2-16.

12. The method of claim 10, wherein a message in which the point in time is exchanged indicates whether the point in time is more or less than a half of a subcycle in the future at a time of sending the point in time.

13. The method of claim 10, wherein the exchanged point in time is not more than half of a subcycle in the future at a time of sending the point in time.

14. The method of claim 10, wherein the exchanged point in time is a point in time relative to a default subcycle clock value.

15. The method of claim 8, wherein offset values which are accumulated in the message are represented by a difference between a clock of a slave node and a clock of a master node.

16. The method of claim 15, wherein a value of the clocks are represented using 28 bits.

17. The method of claim 15, wherein the offset values which are accumulated in the message are retrieved in each node using a host controller interface in each node.

18. The method of claim 1, wherein the offset values which are accumulated in the message include a clock offset and a frame offset.

19. The method of claim 1, wherein the message includes an indication that each node in the route between the source node and the destination node has to process the message prior to transmitting the message to a next node in the route.

20. The method of claim 19, wherein the indication is included in a network adaptation layer message header.

21. The method of claim 1, wherein an address of the destination node is included in a body of the message.

22. A network comprising:
a source node which generates a message and transmits the message in a route between the source node and a destination node;
at least one intermediate node in the route between the source and destination nodes, wherein an offset is accumulated in the message as the message is transmitted in the route between the source node and destination node, wherein whether accumulation is performed by the at least one intermediate node is based on a relationship between the at least one intermediate node and either a node from which the at least one intermediate node received the message, or a node to which the at least one intermediate node is to forward the message; and
wherein the destination node determines an offset relative to the source node using the offset accumulated in the message and synchronizes with the source node using the offset determined by the destination node.

23. The network of claim 22, wherein if the source node is a slave node with respect to a next node in the route between the source and destination nodes, the source node determines a negative offset between the source node and the next node, and the source node includes the negative offset in the message prior to transmitting the message to the next node in the route.

24. The network of claim 22, wherein clocks of the source node, the destination node and the at least one intermediate node are not synchronized such that a clock value of one particular node is independent of a clock value of another node, and wherein a stepping of the clock of each node is independent of each other.

25. The network of claim 22, wherein the accumulation is performed by the at least one intermediate node if the at least one intermediate node is a slave with respect to a node which forwarded the message to the at least one intermediate node, or if the at least one intermediate node is a slave with respect to a node to which the at least one intermediate node forwards the message.

26. The network of claim 25, wherein an offset value is added to the offset in the message if the at least one intermediate is a slave with respect to a node which forwarded the message to the at least one intermediate node, and another offset value is subtracted from the offset in the message if the at least one intermediate node is a slave with respect to a node to which the message is to be forwarded by the at least one intermediate node.

27. The network of claim 25, wherein the at least one intermediate node increments an offset counter in the message, wherein the offset counter is incremented by the at least one intermediate node only if the particular node is a slave node with respect to either a node which forwarded the message to the at least one intermediate node, or a node to which the at least one intermediate node is to forward the message.

28. The network of claim 22, wherein the destination node estimates an error of the offset determined by the destination node.

29. The network of claim 22, wherein the source node and the destination node exchange a point in time and perform a task at the exchanged point in time.

30. The network of claim 29, wherein the task is page scanning, paging, inquiry scanning, inquiring, or a message transfer without prior connection establishment.

31. The network of claim 29, wherein a cycle of clocks in all of the nodes is represented by a predetermined number of bits and the offsets are represented by a difference between a subcycle of a clock of a slave node and a subcycle of a clock of a master node.

32. The network of claim 31, wherein the predetermined number of bits is 28 bits which are numbered from 0 to 27 with the least significant bit being bit number 0 and the subcycle is represented using bits 2-16.

33. The network of claim 31, wherein a message in which the point in time is exchanged indicates whether the point in time is more or less than a half of a subcycle in the future at a time of sending the point in time.

34. The network of claim 31, wherein the exchanged point in time is not more than half of a subcycle in the future at a time of sending the point in time.

35. The network of claim 31, wherein the exchanged point in time is a point in time relative to a default subcycle clock value.

36. The network of claim 29, wherein the offset values which are accumulated in the message are represented by a difference between a clock of the slave node and a clock of the master node.

37. The network of claim 36, wherein a value of the clocks are represented using 28 bits.

38. The network of claim 36, wherein the offset values which are accumulated in the message are retrieved in each node using a host controller interface in each node.

39. The network of claim 22, wherein offset values which are accumulated in the message include a clock offset and a frame offset.

40. The network of claim 22, wherein the message includes an indication that each node in the route between the source node and the destination node has to process the message prior to transmitting the message to a next node in the route.

41. The network of claim 40, wherein the indication is included in a network adaptation layer message header.

42. The network of claim 22, wherein an address of the destination node is included in a body of the message.
